(19) United States
(12) Patent Application Publication
(10) Pub. No.: US 2026/0279224 A1
(43) Pub. Date: Sep. 17, 2026

(54) DIGITAL SPEECH LEARNING SYSTEMS, DEVICES, AND METHODS

(71) Applicant: GLOBAL EFFECTIVE EDUCATION LTD, Herzliya (IL)

(72) Inventor: Solly Shlomo TAMARI, Herzliya (IL)

(21) Appl. No.: 19/472,878

(22) PCT Filed: Apr. 17, 2024
(86) PCT No.: PCT/IL2024/050380

§ 371 Date: Oct. 6, 2025

Related U.S. Application Data
(60) Provisional application No. 63/460,754, filed on Apr. 20, 2023.

(51) Int. Cl. G09B 19/06; G10L 15/26; G10L 25/63

(52) U.S. Cl. CPC G09B 19/06; G10L 15/26; G10L 25/63

(57) ABSTRACT

There are provided methods, systems and devices for digital speech learning, comprising: receiving an audio input of the user speaking a content; processing the recording using a Language Recognition and Response System (LRRS), transcribing the audio input to text, wherein said transcribed text comprises correct language text and language mistakes; identifying the correct language text and language mistakes in said audio input to yield language practice results; and processing the audio input using an Emotion System, analyzing the audio input to identify and measure Long-Term Potentiation (LTP) level of the user by correlating vocal parameters extracted from the audio input to the emotional state of said user; displaying transcribed text; and if said LTP level and the number of mistakes are below a threshold then: providing feedback to the user, and repeating and analyzing the recorded content until the LTP level and number of mistakes are above the threshold.

### CROSS-REFERENCE

The present application claims priority to U.S. Provisional Application Ser. No. 63/460,754 filed on Apr. 20, 2023, entitled “DIGITAL SPEECH LEARNING SYSTEMS, DEVICES, AND METHODS” (attorney docket no. EZ001/USP) which is incorporated herein by reference in its entirety.

### TECHNICAL FIELD

The present invention, in some embodiments thereof, relates to systems, devices, and methods for language learning, and more specifically, but not exclusively, to digital speech learning systems, devices and methods that utilize machine learning algorithms to provide personalized feedback and optimize learning outcomes.

### BACKGROUND OF THE INVENTION

Acquiring proficiency in spoken language, particularly English, presents a significant challenge, surpassing that of listening, reading, or writing. Despite achieving comprehension and success in written examinations, research indicates a notable struggle among individuals learning English as a second or foreign language (ESL—English as a Second Language—or EFL—English as a Foreign Language) in attaining fluency in speech. This challenge stems from the rapid cognitive processing demanded during conversation, akin to the cognitive demands of driving. Regrettably, conventional teaching methods, such as those employed in schools and language learning applications, fall short in effectively cultivating speaking proficiency.

Despite the numerous language learning solutions available in the market today, such as Duolingo, Babbel, and traditional ESL schools, they cannot effectively teach learners how to speak a language.

Current methods prioritize the memorization of grammar rules and written tests, with passing scores typically around 65%, leaving a substantial amount of information unlearned. Moreover, even though these methods involve spoken exercises, they do not provide sufficient repetition until the learner has achieved mastery, and there is no way to confirm if the student has made progress in their English speaking skills. Many of these approaches are based on Noam Chomsky's Universal Grammar method from the 1950s, which has since been discredited.

In view of the foregoing, there is a need for advanced systems, devices, and methods that can effectively teach learners how to speak a language.

### SUMMARY OF THE INVENTION

There is provided a computer-implemented method for digital speech learning by a user, comprising: receiving a recording, via a network to a client device, said client device comprising a processor and a display, wherein the recording comprises an audio input of the user speaking a content; analyzing said audio input, using the processor, wherein said analyzing comprises: processing the recording using a Language Recognition and Response System (LRRS), said processing comprises: transcribing the audio input to text, wherein said transcribed text comprises correct language text and one or more language mistakes; identifying the correct language text and the one or more language mistakes in said audio input to yield language practice results; and processing the audio input using an Emotion System, wherein said processing comprises: analyzing the audio input to identify and measure Long-Term Potentiation (LTP) level of the user by correlating vocal parameters extracted from the audio input to the emotional state of said user, at the time of speaking the content, in relation to said content; displaying on said display said transcribed text; measuring if said LTP level and the number of language mistakes are above or equal a predefined threshold and if said LTP level and the number of mistakes are below said threshold then: providing a feedback to the user to repeat recording the content; and repeating and analyzing the recorded content until the LTP level and number of mistakes are above the predefined threshold.

In an embodiment, the transcribing comprises: converting the one or more language mistakes in the audio input into text output using a Language Speech to Text Engine (LSTT), said LSTT is configured and enabled to not automatically correct the language mistakes; and comparing the text output to the content, using a comparison module, to yield the language practice results or said feedback.

In an embodiment, the language practice results comprise the one or more language mistakes and feedback, said feedback comprises a correct or incorrect reply in respect to the audio input.

In an embodiment, the method comprising: providing feedback on the accuracy or correctness of the language used in the recorded content.

In an embodiment, processing the audio input using the Emotion System comprising: processing the audio input, using an emotion detection engine to yield a plurality of biomarkers; processing said plurality of biomarkers, using a biomarkers processing module to yield emotion results or said LTP or said feedback; displaying said emotion results or feedback.

In an embodiment, the method comprising: highlighting language mistakes in said transcribed text.

In an embodiment, the language mistakes are one or more of: grammatical errors; incorrect verb tense usage, subject-verb agreement issues, and improper sentence structure within the given content.

In an embodiment, the method, comprising: setting a time limit for exercising said content; measuring whether the user made any language mistakes within said time limit; and determining if the user's performance LTP level exceeded the predetermined threshold within said time limit.

In an embodiment, the method further comprising using a Text-to-Speech (TTS) engine to audibly present said emotion results or feedback.

In an embodiment, the method comprising processing the audio input using an Emotion System comprising: analyzing the recording to identify one or more emotions by correlating vocal parameters extracted from the recording to the emotional state of said user at the time of recording and in relation to the content being recorded.

In an embodiment, the method comprising: measuring the intensity or level of said identified emotion, resulting in one or more emotion parameters; and displaying the identified emotions along with their corresponding intensity levels.

In an embodiment, the method comprising playing the content audibly.

In an embodiment, the method comprising replaying the content audibly if said LTP level and the number of mistakes are below said threshold.

In an embodiment, the content is unknown, and the audio input is processed and analysed using two model types, simultaneously: a Model based on Phonemes which has an error rate worse than 18%; and a Model based on Words that will compensate the error rate in the Phonemes Model.

According to a second aspect there is provided a system for digital speech learning by a user, comprising: a storage subsystem configured and enabled to store content; a client device comprising a microphone configured and enabled to record the user speaking said content and to yield a recording comprising audio input of said content; and a processor, said processor comprises: a Language Recognition and Response System (LRRS), configured and enabled to: transcribe the audio input to text, wherein said transcribed text comprises correct language text and one or more language mistakes; identify the correct language text and the one or more language mistakes in said audio input; and an emotion system configured and enabled to: analyze the audio input to identify and measure Long-Term Potentiation (LTP) level of the user by correlating vocal parameters extracted from the audio input to the emotional state of said user at the time of said recording and in relation to said content being recorded; and wherein said processor is configured to:
measure if said LTP level and the number of language mistakes are below a threshold and if the affirmative then: provide feedback to the user to repeat recording the content; and
repeat and analyze the recorded content until the LTP level and number of mistakes are above the predefined threshold.

In an embodiment, the measured level of the LTP is displayed as an emotion meter, wherein said emotion meter provides a visual representation of the intensity or magnitude of the LTP detected in the recording.

In an embodiment, the emotion system is configured and enabled to: analyze the audio input to identify and measure the emotion level of the user by correlating vocal parameters extracted from the audio input to the emotional state of said user at the time of said recording and in relation to said content being recorded.

In an embodiment, the measured level of each identified emotion is displayed as an emotion meter, wherein said emotion meter provides a visual representation of the intensity or magnitude of each emotion parameter detected in the vocal recording.

In an embodiment, the vocal parameters are selected from the group consisting of: Pitch variation, Speech rate, Volume, Tone quality, and Vocal intensity.

In an embodiment, the system comprising: a TTS (text to speech) system for playing the content audibly.

In an embodiment, the system comprising: replaying the content audibly using said STT if said LTP level and the number of mistakes are below said threshold.

The feedback mechanisms, in accordance with embodiments, is tailored to the student's learning needs and goals.

In an embodiment, the content is received by the user from any known source.

### BRIEF DESCRIPTION OF THE DRAWINGS

A better understanding of the features and advantages of the present disclosure will be obtained by reference to the following detailed description that sets forth illustrative embodiments, in which the principles of embodiments of the present disclosure are utilized, and the accompanying drawings.

FIG. 1 is a schematic diagram of a digital speech learning system 100, in accordance with embodiments;

FIG. 2A shows a high-level block diagram of a digital speech learning system and method for providing personalized feedback and optimizing learning outcomes, in accordance with embodiments;

FIG. 2B shows a high-level flowchart of a method for digital speech learning, in accordance with embodiments;

FIG. 2C, shows a detailed block diagram specifying the various modules included in the digital speech learning system, in accordance with embodiments;

FIG. 3 shows a block diagram specifying the various modules in the digital learning system, in accordance with embodiments;

FIG. 4 illustrates a flowchart detailing the steps for a student to engage with the digital speech learning platform, in accordance with embodiments; and

FIG. 5A, FIG. 5B, FIG. 5C and FIG. 5D show various screenshots of the speech learning platform as displayed for example on the user's device, in accordance with embodiments.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore, the invention is not limited by that which is illustrated in the figure and described in the specification, but only as indicated in the accompanying claims, with the proper scope determined only by the broadest interpretation of said claims.

The term ‘content’ or ‘practiced content’ or ‘practicing content’ as used herein and through the specification and claims should be understood to encompass the text such as expected text that the user actually needs to practice/learn, e.g., the content may include for example one or more sentences or paragraphs including missing words, and or where some of the words are in another language. For example, for a French person practicing English the content may include text in English while selected words are in French, and the student needs to translate the French words to English. In some cases, the content may be any textual content, in digital format and/or converted to a digital format through OCR or other methods. In some cases, the content may be textbooks from schools or teaching companies such as Berlitz, exercises on websites, content from other apps such as Duolingo, presentations, articles, etc. In some cases, the content may include fill-in-the-blanks exercises, presentations to practice, foreign text to translate to English, and the like. In some cases, the content comprises long texts to enable the user to practice pronunciation. In some cases, the content may be audio content which the user needs to repeat and practice.

As used herein, like characters refer to like elements.

Current language learning solutions available in the market today, such as Duolingo, Babbel, and traditional ESL schools, don't effectively teach learners how to speak a language. This is because of these solutions:
A. Do not align with the natural way in which human brains learn, which is through achieving Long Term Potentiation (LTP) through repetition, immediate corrective feedback, spaced repetition etc.; and
B. They use conventional STTs (Speech-to-Text) engines that DO NOT provide correct feedback on mistakes. For Example: If the student says aloud the word “encypedia” instead of “Encyclopedia”, the traditional STT will immediately and automatically respond with the answer “encyclopedia”, and as a result, the students won't know that they actually made a mistake.

In the field of neurophysiology, the phenomenon known as Long-Term Potentiation (LTP) and Procedural Memory is a key aspect of neural plasticity and has significant implications for enhancing cognitive functions.

LTP is a persistent strengthening of synapses based on recent patterns of activity. These are patterns of synaptic activity that produce a long-lasting increase in signal transmission between two neurons.

In other words, LTP involves the persistent strengthening of synaptic connections between neurons, leading to an increased efficiency in signal transmission. This concept draws an analogy to the establishment of a well-defined pathway in a forest, where repetitive activation of specific neural pathways results in a gradual refinement and strengthening of the connections between neurons.

The present disclosure leverages the principles of LTP to improve learning and memory capabilities and especially speaking, by fostering the development of more robust and effective neuronal connections.

In accordance with embodiments, there are provided systems devices and methods which utilize the way the human brain naturally learns through Long Term Potentiation (LTP). The methods and embodiments in accordance with embodiments include using spoken exercises, repetition until mastery, and further uses techniques to verify the establishment of necessary synaptic connections.

Moreover, the present invention aims to diverge from conventional methods that prioritize the memorization of grammar rules and written tests, which are ineffective. By utilizing the proposed systems and methods, which comprise built-in Real-Time feedback system, learners will have the opportunity to acquire language skills more efficiently and effectively, resulting in improved language proficiency and enhanced communication abilities.

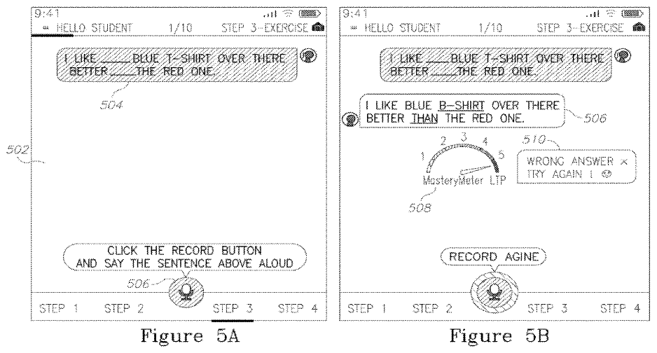

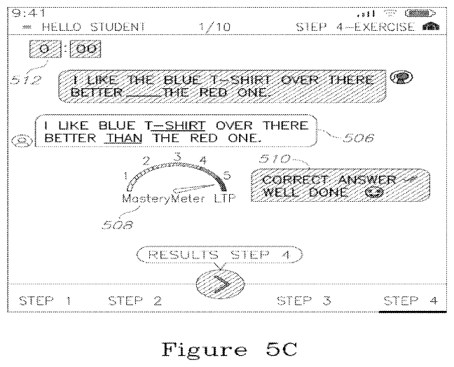

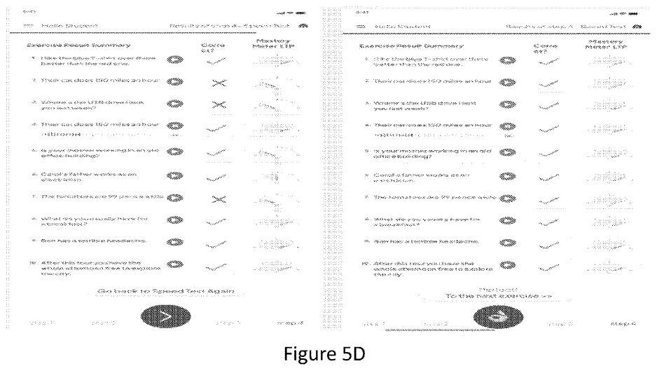

In accordance with embodiments, the student's goal will be to provide the correct answers while achieving Positive LTP (e.g. level 4-5 out of 5 or Green, as shown in FIG. 5B and FIG. 5C) in the learning process, for example in a Speed Exercise. In some cases, the exercise is timed, 1-5 minute exercise where the user has to speak out loud the correct answers automatically. If the user needs to think about the answer, then the User will exceed the time limit and need to repeat it.

The present invention, in some embodiments thereof, relates to systems, devices, and methods for digital speech learning, and specifically, but not exclusively, to digital speech learning systems that utilize computer systems and methods such as machine learning algorithms and systems to provide personalized feedback and optimize learning outcomes. These systems and methods may include speech recognition software, natural language processing algorithms, emotion detection methods and adaptive learning technology to adjust to the user's proficiency level and individual learning needs. Devices that may be used in conjunction with these systems include computers, smartphones, tablets, and other digital devices with speech input and output capabilities. Methods for implementing these systems may involve analyzing speech patterns and errors, providing corrective feedback, and tracking progress over time to tailor instruction and improve fluency.

Specifically, the disclosed invention relates to a computer-implemented method, device and system for providing real-time feedback to a user, such as a student, on an App or Web application.

In some embodiments, the method, system and device include displaying to the user the levels of each required parameter speaking skills, such as concentration levels, and thinking level with the intent of improving their performance.

More specifically, the users are provided with immediate feedback that encourages them to strive for the “Green” level (e.g. mastery level of language skills), as determined by systems devices and methods, in accordance with embodiments. The feedback is generated based on the user's input and the system's analysis of the input, using algorithms and other computational techniques. The invention further enables users to monitor their progress and make adjustments, for example in real-time, leading to improved language-speaking outcomes.

In accordance with embodiments, the systems and methods include using an emotion engine and a Language Recognition and Response System (LRRS) which comprises a speech recognition module such as an LSTT (Language-Speech-to-Text) engine to provide personalized feedback and optimize learning outcomes.

The LSTT is configured to determine the spoken language utilized by a user. Specifically, the LSTT is configured to transcribe the user's exact spoken utterances into for example textual form. For example, the LSTT is configured and enabled to receive the user's speech and break down sentences and words of the speech in to phonemes and syllables and displaying/announcing the actual sounds, even if they are not valid words from the dictionary. A comparison module which comprises an error detection module analyzes the transcribed text to identify any deviations from established linguistic norms and conventions.

The unique feature of the LSTT is that it displays what the student said, even if, for example, such a word doesn't exist in the tested language. e.g. in case of errors and/or mispronunciations, the LSTT will display the syllables, and not the closest word in the dictionary, as do all other STTs.

In one embodiment, the LRRS is configured and enabled to identify the language as pronounced by the user (e.g. the student) and respond to the above by displaying and/or announcing the text as pronounced by the user. For example, following the above example, if the user said: “encypedia” the system will display and/or announce the word “encypedia” and tell/display to the student that he made a mistake and that he should repeat the practiced content until it is pronounced correctly.

The methods and systems, in accordance with embodiments, include using Linguistics methods and are configured to measure the result of the usage of LTP.

In accordance with another embodiment, there are provided methods and systems for measuring LTP for example in real-time, using voice analysis. These methods and systems include using voice analysis without any other apparatus required.

It is stressed that none of the prior techniques have measured LTP using voice analysis, since LTP is a neurophysiological process that occurs at the synaptic level in the brain. In some embodiments, the LTP may be measured using Nemesysco's engine.

Traditional Voice analysis can reveal information about speech patterns, prosody, and linguistic features, but it cannot directly measure synaptic plasticity such as LTP. In accordance with one embodiment, there are provided methods for measuring LTP parameters using a unique Voice Analysis mechanism that does not analyze the content. It does this analysis by ignoring the content of what the subject is saying, and the language being used, and instead focuses on the patterns and anomalies in the speech flow of the user. This unique ability provides the user with immediate feedback (e.g. in real-time) on these LTP parameters. This feature, combined with the other proven features of the system, will increase the efficacy of learning significantly.

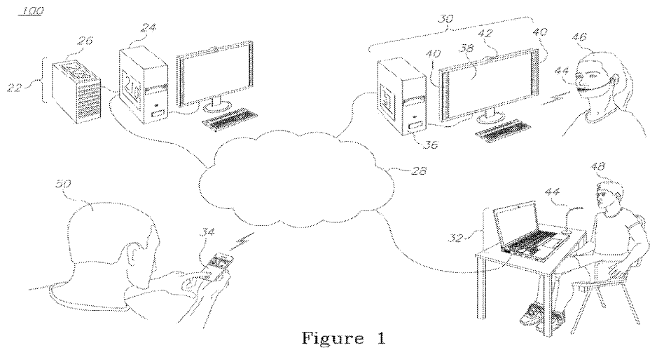

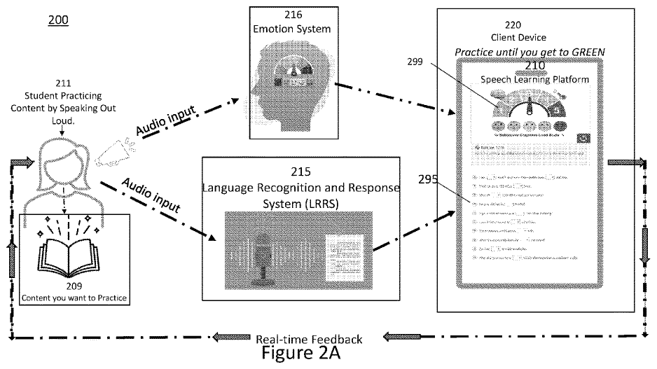

FIG. 1 is a schematic diagram of a digital speech learning system 100, in accordance with embodiments. A media server 22 comprises a processor 24 which may store one or more digital learning applications or platforms such as Speech Learning Platform 210 and a memory 26, which may store data such as learning content 209. Memory 26 also stores a plurality of recordings such as, content and/or learning or practicing recordings that processor 24 has received from user clients, such as client devices 30, 32, 34.

Typically, server 22 comprises a suitable general-purpose computer (or a cluster of such computers), which has been programmed in software to carry out the functions that are described herein. This software may be downloaded to the computer in electronic form, over a network, for example.

Additionally or alternatively, the software may be stored on tangible, non-transitory computer-readable media, such as magnetic, optical, or electronic memory media. Server 22 communicates over network 28 with multiple client devices 30, 32, 34. Typically, network 28 comprises the public Internet, and server 22 communicates with the client devices via a suitable Web interface, as is known in the art. Alternatively, the server and clients may communicate using any other suitable sort of network and interface. Client devices 30, 32, 34 may comprise, for example, desktop, laptop, or tablet computers, media consoles, personal digital assistants or mobile devices such as communication mobile devices (e.g. smartphones), or any other sort of device with the types of networks, video and/or audio interfaces and computing capabilities needed to interact with server 22.

By way of example, client device 30 comprises a computer with a processor 36, memory 37, video display 38 and speakers 40 for playing content such as the practicing content, i.e. English text and the like, along with for example a video camera 42 and microphone 44 for recording. Client devices 32 and 34 are similarly equipped, though in different configurations. In operation, users 46, 48 and 50 may receive and/or download the digital learning application, e.g. Speech Learning Platform 210 for example on their devices 30, 32 and 34 and/or upload the respective users' recordings via the network to server 22. Server 22 shall store the actual software application for downloading upon demand to the User end device (PC, Cellphone, Tablet, etc.).

In some embodiments, the server 22 is also configured and enabled to manage and store, for example on memory 26, user and/or teacher and/or parent data including lessons and results. In addition, it may store an ever-growing repository of content uploaded by the user/teacher/parent. For example, the system and method in accordance with embodiments, comprise augmenting existing software programs and digital content. Specifically, system 100 comprises a database for storing said existing programs and content. The database is configured to be accessed by users, such as students when they require the stored programs and content. Furthermore, the database allows for additional programs and content to be readily incorporated, thereby enabling the expansion of the available resources.

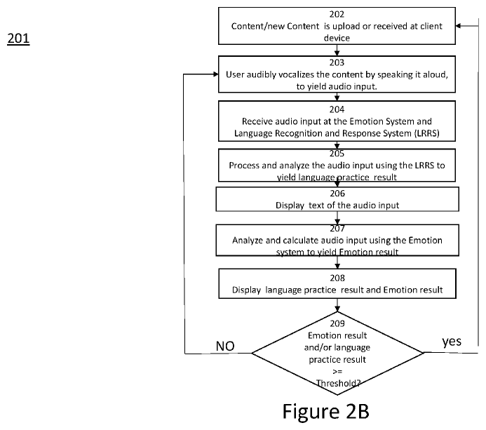

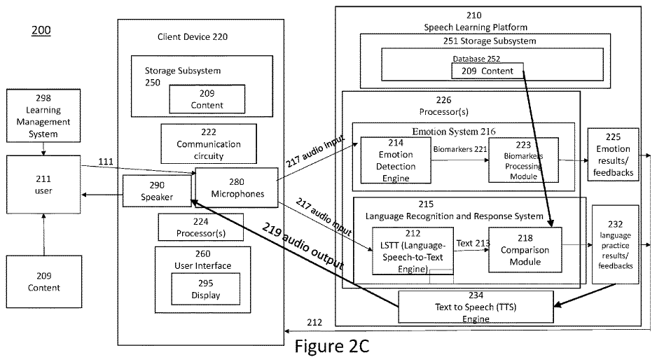

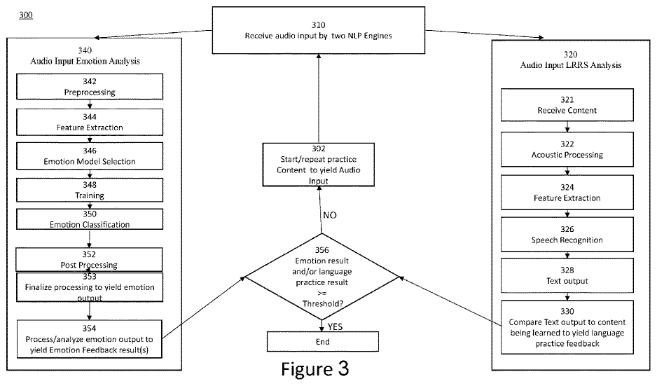

Processor 24 is configured to receive and store the users' recordings for example in memory 26. Users 46, 48 and 50 may select content stored on memory 26 and request server 22 to play the selected content on the users' device. As will be further illustrated in details below in respect to FIG. 2A-Figure 3, processor 24 is configured to perform, analyze and control the digital learning process.

In some embodiments, the content and/or Speech Learning Platform 210 may be received and/or downloaded directly (e.g. not via Server 22) to the users 46, 48 and 50 devices 34, 32 and 36 from local or external storage devices.

Reference is now made to FIG. 2A and FIG. 2B which show, respectively, high-level block diagrams of a digital speech learning system 200 and method 201 that utilize at least two NLP (Natural Language Processing) Engines such as Emotion System 216 and Language Recognition and Response System 215, and machine learning algorithms to provide personalized feedback and significantly increase learning outcome efficacies, in accordance with embodiments.

While FIG. 2A-FIG. 2C only illustrates a single user 211 using a single client device 220 to make it easier to describe and understand the invention, it should be understood that the invention may be practiced as part of a larger computer network, where any number of users 211 may use the invention at the same time.

With reference to FIG. 2B, the digital speech learning system 200 shown in FIG. 2A comprises the following methods steps: At step 202, content 209 (e.g. new or existing content) to be learned and practiced is optionally uploaded, for example, to a client device 220, and/or downloaded and/or received from an external device such as content stored in memory 26 of server 22 (as shown in FIG. 1). The content 209 may be displayed for example by speech learning platform 210 at the client device 210 display 295. For example, FIG. 5A shows screenshot 502 of the speech learning platform 210 as displayed for example on the user's device. The content 209 includes a number of sentences such as sentence 504 which includes blank underlined sections which the user needs to complete as part of the learning process. Specifically, sentence 504 is “I like ______ blue T-shirt over there better ______ the red one” which the user needs to complete, say and record himself while saying this sentence 504.

Optionally, in some cases the content 209 is converted to speech using TTS (Text to Speech) system to allow the user to listen to the content 209, for example, before he practices the content 209.

For example, sentence 504 is announced so the user can listen to it and how it should be pronounced before he starts practicing it.

At step 203, user 211 audibly vocalizes the content by speaking it aloud, optionally using an audio input device such as a microphone to capture the spoken audio and to yield audio input (e.g. user's recording-voice input such as a recording including user's exercising the content). For example, as shown in FIG. 5A the user clicks on the record button sign 506, and says sentence 504.

In some cases, the user's voice is captured using recording devices, such as audio and/or video recording devices to yield recording input (e.g. audio input 217) of the user. In other words, the audio input 217 covers both audio and any type of recording.

At step 204 an Emotion module 216 and Language Recognition and Response System (LRRS) 215 receive the audio input 217 (e.g. spoken content/recording), for example simultaneously. Following the receipt of the spoken audio at step 205 the LRSS 215 processes and analyzes the audio input to verify its accuracy, for example, by determining whether the user successfully pronounced the content correctly in terms of for example grammar and/or accent, to yield language practice results and/or feedback including for example output results based on the accuracy level of the spoken content. For example, as shown in FIG. 5A the feedback may be message 510 ‘Wrong answer, try again’.

Optionally, at step 206 the LRRS displays a text of the audio input as exactly recorded and said by the user, including the user language mistakes converted to text by the LRRS. For example, as shown in FIG. 5B the text 506 is “I like the blue B-shirt over there better than the red one” is displayed on screen 502 is the exact audio input of the user transcribed to text, including the user mistake ‘B-shirt’.

Additionally, following the receipt of the spoken audio 217, at step 207 the Emotion System 216 processes and analyzes the audio input 217 to yield Emotion Result(s) and/or emotion levels including for example the LTP level in the brain of the user, for example at the moment he practiced the content and provided/recorded the spoken audio. Specifically, according to one embodiment, the analysis comprises analyzing the recording to measure LTP level of the user by correlating vocal parameters extracted from the recording to the emotional state of said user at the time of recording and/or in relation to the content being recorded. Hence, the audio input 217 is analyzed to identify vocal parameters extracted from the recording and correlate them to human emotions and other brain functions of the user. According to one embodiment, the LTP is measured by analyzing voice frequencies that are below the frequencies that human beings can hear.

In accordance with embodiments, other emotion parameters may be measured.

In accordance with embodiments, an LTP level may be defined for example between 1=low to 5=high. According to one embodiment, an LTP level is measured by ignoring the content of what the user is saying and the language being used, and instead focusing, for example on the patterns and anomalies in the speech flow. The LTP level may be displayed in real-time to the student on a numbered and colored meter from 0-5 and from red to green as shown in FIG. 5B. Currently, prior art devices and methods are not able to measure LTP using voice, and in Real-time.

At step 208 the language practice result and the emotion result are optionally displayed for example on the client device, for example, following every verbal response as illustrated in FIG. 5A-FIG. 5C.

For example, as shown in FIG. 5B a language practice results 510 includes a message ‘wrong answer try again’ and a sad icon along with an emotion meter such as a MasteryMeter LTP 508. The MasteryMeter LTP 508 presents the LTP level when the student practiced the sentence 506. Specifically at this session the LTP level is high, however since there is a language mistake, the student will need to repeat sentence 506.

In some cases, the Speech Learning platform 210 is configured and enabled to present the feedbacks to the student orally and visually, for example, in real-time—whether the student's response is right or wrong. For example, if the student is wrong, tell the student out loud or/and display “No”, then tell the student out loud or/and display “Please try again”.

At step 209 the emotion result and the language practice result are calculated to determine whether each or both results are equal or higher than a predefined threshold.

If the calculated results are indeed higher than the predefined threshold than the speech learning process ends and for example feedback message such as “excellent you succeeded” may be displayed or announced and the process may proceed back to step 202 for practicing a new content. If the graded emotion and/or the language practice results/grade are lower than the threshold than the flow proceeds in a loop to step 203 to practice again the content, and optionally a feedback message ‘try again’ may be displayed to the user. For example, the user repeats the same content practiced earlier and steps 203-207 are repeated in a loop till the graded emotion and/or the language practice results are higher than the threshold.

For example, if the answered output result is incorrect and/or the LTP is below a predefined threshold, then a feedback message ‘incorrect, try again’ is displayed following step 208 and the process goes back to step 203 where the user is asked to repeat the language exercise (e.g. repeat speaking the content). Specifically, with respect to LTP, Steps 203-206 are repeated in a loop until the user reaches a correct answer and/or the LTP is equal or above the predefined threshold. If the received output result is correct and/or the emotion LTP is equal or above the predefined threshold then the user receives feedback that he successfully passed the language exercise and he may now try practicing another content at step 202.

For example, the emotion result may be the user's emotion level displayed in the form of emotion meter 299 where the emotion level is graded between 1-5 and/or according to color level where red present low and green high. For example, as shown in FIG. 5B and FIG. 2A the emotion meter may be a MasteryMeter LTP 508 or Emotion meter 299 which may relate, respectively to the student LTP level (three in the example shown in FIG. 2A or green in the example shown in FIG. 5B) or to the general emotion of the user.

In one embodiment, the LTP level may be defined as ‘Mastery Level’ indicating based on the user voice analysis and/or extracted biomarkers the user's LTP level. The LTP level indicates how strong the speech practice was caught and understood in the user's brain, where a high grade in the scale between 1-5, for example 4 or 5 indicates the user speech practice and the language was clearly understood by the user, while a low grade indicates that the user still didn't catch the speech practice.

In addition, in some embodiments, the Language practice result may be displayed for example ‘correct’or ‘incorrect’.

In one embodiment, the language practicing process may have a time limit. For instance, the speech learning platform 210 could display a clock on the device screen, requiring the user to complete each language practicing iteration (e.g. steps 203-208) within a specified timeframe.

Reference is now made to FIG. 2C, which illustrates a detailed block diagram of the digital speech learning system 200 in accordance with embodiments. System 200 includes a Speech Learning Platform 210 which is configured and enabled to communicate with a client device 220 used by a student, such as user 211. The Speech Learning Platform 210 comprises or may be included in one or more processors 226 which comprises an Emotion System 216 that in combination with a Language Recognition and Response System (LRRS) 215, performs the steps and processes described herein for determining a language learning process of the user 211.

The arrows between the client device 220 the Speech learning platform 210 the user 211 and the content 209 represent one or more computer networks or communication pathways.

Communications over the one or more computer networks or communication pathways may use any desired protocols.

The user 211, typically a student, employs a client device 220 exemplified by, but not limited to, a mobile device such as a cell phone (e.g. smartphone), PDA, tablet, dumb computer, laptop computer, desktop computer, and the like. This client device 220 utilizes communication circuitry 222 to establish communication with the speech learning platform 210. In certain embodiments, the client device 220 is configured and equipped to both incorporate and receive content 209. This content 209 may encompass physical and/or oral materials such as textbooks transformed into digital content, downloadable content, and/or digital content, including text intended for user practice, content digital content downloaded for example from the web or transformed using OCR, etc.

In specific implementations, the physical content may take the form of a digital book designed for language practice, such as an English language book for the purpose of English language practice, or articles from newspapers such as New York Times or any other such type of printed material. In other embodiments, the content 209 may be or may include dedicated language practice platforms, specifically generated for the speech learning platform 210.

In some embodiments, the content 209 may reside at the backend of a software system, such as client device 220 Storage Subsystem 250, or at the speech learning platform or server 22. In many applications, especially those with a client-server architecture, digital content is typically stored in a database or on a file system managed by the backend servers.

In some embodiments, the backend is used to receive the content 209 including the exercise/task data (such as text to be practiced), the correct and/or expected data, and the exercise data which could be complete and/or with gaps.

In some embodiments, the system may receive external input data from a variety of sources, e.g. websites, textbooks, apps, articles, OCR, and the like.

In some embodiments, system 200 may display the data to the user using the speech learning platform 210, for example on the user's mobile phone (e.g. client device 220).

In some cases, the content 209 may be provided and displayed as the following two input screens:
1. The first screen displays a digital copy of the Correct Content (or Expected Content). For example: “I am happy” (as shown in the display 295 in FIG. 2A).
2. The second screen displays the practice content that includes one or more BLANKS to be filled in by the student. For Example: “I ______ (be) happy” (as shown in the display 295 in FIG. 2A).

The two Input Screens may also accept longer texts, for example up to 5000 characters or more if needed.

In some cases, the speech learning platform 210 may feature an input interface equipped with OCR (Optical Character Recognition) technology, which allows for utilization of for example a mobile camera to capture text from printed materials.

In some cases, the speech learning platform 210 is configured to select and tell the student what content to practice, and what is the expected correct result.

In some cases, the speech learning platform 210 is configured to remind the student to practice according to a pre-determined schedule.

In some cases, the speech learning platform 210 is configured to Start a fast speaking exercise such as 1-minute Speed Exercise forcing the student to use their Automatic Memory (The exercise length will be adjustable). Automatic Memory is defined as the Long Term Procedural Memory. Procedural memory is a part of the implicit long-term memory responsible for knowing how to do things, i.e., memory of motor skills.

In some cases, the backend may include a dynamic, growing database of content 209 that has been input over time for the use of other students. In some cases, the content may be searchable by various methods to be determined, for example by the user.

The backend may also have a Google Translate feature to allow practicing translation from one language to another while speaking. For example: if the user wants to practice retrieving the sentence: “I am happy” from the Hebrew sentence: “ [symbol] ” (i.e. ‘Ani Sameach’). This allows practicing with a mobile phone while walking, riding, driving, on a treadmill or just sitting at home and practicing speaking.

The system may also use AI engines such as CHAT4 and other AI platforms to easily allow the modification of text input for practice purposes. For example:
Change the level of text from a New York Times Article to a CEFR level A2.
Delete all the Prepositions from a text to allow practicing retrieval of spoken Prepositions.
Rewrite any sentence in all the tenses.

According to one embodiment the systems and methods do not include any content, hence, the content may be received, for example using the network, from external sources, for example, according to content the user desires and/or is given to practice.

In some embodiments system 200 comprises a learning management system 298 (LMS) to manage student registration to the Speech learning Platform 210, which is configured and enabled to:
Manage user (e.g. student) registration to the speech learning platform 210;
Manage task assignments per user (e.g. Personalization) where the exercises are assigned per user, based on their specific needs, store score and the like such as patterns of problems across many students.
Manage Affiliate registration, where the teacher/tutor is the affiliate, and the student “belongs” to that affiliate;
Manage charging the student and paying affiliate commissions;
Manage Parent/Student registration where the Parent is the one paying while the Student uses the system.

In some embodiments, the learning management system 298 is configured to collect data related to the correct and incorrect answers for each student.

In some embodiments, the learning management system 298 is further configured to produce various reports for the student and/or the Teacher for example, through a built-in LMS system or through available Third-Party LMS providers. For example, the client device 220 and/or the speech learning platform 210 may be in communication with a 3rd party LMS systems, for example through APIs (Application Protocol Interfaces).

The systems and methods are also configured to transmit to the user exercise result information via one or more External LMS systems.

Systems and methods in accordance with embodiments are further configured to manage task assignment, scorekeeping and the like, including the following:
Accept and track the content to be learned from the Backend to accept the Exercise/Task data.
Manage the scheduling and tracking of the actual learning process.

The client device 220 operates a user interface 260 to show the content 209 to the user 211, typically on a display 295. The client device 220 also preferably includes one or more sensors such as microphones 280 for recording the user's practicing the content 209 and/or spoken responses from the user 211, a speaker 290 used, for example, to announce to the user 211 the practice results, the content (e.g. before the user starts practicing) and feedbacks, and a communication circuitry 222 comprising one or more transmitters/receivers and or transceivers to transmit/receive data, including, for example, audio input 217 and audio output 219 (e.g. audio input/output signal(s)) of spoken words) and/or content to/from the speech learning platform 210.

In accordance with embodiments, the Language Recognition and Response System 215 comprises a Learning-Speech-to-Text engine (LSTT) 212 and a comparison module 218.

The LRRS 215 is configured and enabled to receive the audio input 217 (for example form the client device 220) analyze it and generate language practice results and/or feedbacks to the user. The feedback includes, according to one embodiment, language practice feedback 232. Specifically, the language practice results/feedback 232 comprises the actual output from the LSTT engine, with the mistakes or errors highlighted. The language practice feedback may also comprise the language practice result. The result may be for example a ‘correct’ or ‘incorrect’ result or a specific result such as: ‘encyclopedia’ as the expected correct result, and ‘encypedia’ as an incorrect response.

More specifically, the LRRS 215 may be or may include an NLP engine. The LRRS 215 comprises the LSTT 212 which is configured and enabled to transcribe the received audio input 217 to text output 213. For example, the LSTT 212 is configured to convert the speech sound, such as the audio input 217, to digital content e.g., text 213. The text output 213 is further transmitted to the comparison module 218 which, according to one embodiment identifies language errors by, for example, comparing the text output 213 to the content 209 to yield language practice results/feedback 232 to the user. For example, the comparison module 218 may include an error detection module which analyzes the transcribed text to identify any deviations from established linguistic norms and conventions. Upon detection of an error and/or language mistake, defined for example as anything different from the content, the speech learning platform 210 is configured to halt the student's activity and provide feedback in the form of a message spoken message, for example, via the LRRS, stating a message such as “STOP! Try again”. For example, as shown in FIG. 5B the LRRS provides the transcribe text 506 which presents the student's mistake “B-shirt” for example in a color red and green color for the correct answer “than”.

As shown in FIG. 5B the LRRS 215 doesn't automatically corrects the user but rather presents the mistake to the user and provides a feedback which may include a message 510 “wrong answer”. This way the student will need to practice again and try finding the correct answer by himself. In addition, the platform will display an emotion level/type (e.g. LTP) reading for that specific sentence 506. This is very important, as in many cases the user might say a mistake yet will be sure that it is correct. This is also very important and can only be seen with the combination of the present invention's two NLP engines—the emotion system 216 and LRRS 215, since correcting a mistake is much harder to achieve than learning something new to Mastery.

According to one embodiment the LRRS 215 is configured and enabled to respond rapidly to the user input (e.g. to provide the transcribed text of the audio input 217) for example less than 1, 2, 3-10 seconds, thus to enable a speed exercise where the student must answer a number of texts in one minute. For example, the LRRs 215 is configured to respond immediately with a yes/correct or no/incorrect spoken response to every sentence question in the content 209.

In accordance with one embodiment, the LSTT engine 212 comprises a Fast STT Engine, which is configured to generate Text output 213 and provide fast and/or real-time feedback to the user. For example, the LSTT Engine 212 and the comparison module 218 are configured and enabled to perform the LSTT process and comparison to the expected content within for example less than 500 milliseconds from the end of the user speaking each sentence or word.

It should be emphasized that existing/commercial speech-to-text (STT) and/or Fast STT engines available on the market may not be suitable for use or inclusion in the LRRS 215. This is because conventional STT engines are not configured for speech or language learning purposes, as the commercial STT receive audio input from the student, converts the audio to text and automatically correct user language mistakes. This automatic correction circumvents the step-by-step LTP learning process that is a key aspect of the present invention.

In accordance with embodiments, the LRRS 215 is configured in two options 1) for cases where the content is known to the LRRS 215 (e.g. the expected practice text is known) 2) for cases the content is unknown (e.g. the expected practice text is not known to the system).

In the first option the LSTT 215 converts the audio input to text, e.g. the exact words as pronounced by the student. The comparison module 218 compares the text to the content to identify language errors. If there is a match above a predefined threshold between the text and content then the correct word, e.g. the word as correctly should be pronounced is displayed and/or announced. If the match between the text and the content is less than the threshold, hence the student answer is incorrect, then the system displays the audio input comprising the phonemes/syllables as heard from the user and DOES NOT CORRECT (e.g. an autocorrection is not activated) the student mistake. It should be stressed that the system and method in accordance with embodiments do not use intentionally an Artificial Intelligent (AI) or any known autocorrect systems for manipulating the audio input as used for example by existing STT systems. The reason for that is to keep and identify the language mistakes of the student, present the mistakes and let the student learn from his mistakes until he corrects his mistakes by himself. At the following step the student will need to repeat the content until the content is pronounced correctly, e.g. above the threshold.

In some cases, the threshold may be defined as a match of over than 95% between the content and the text. The threshold may be less or more than 95%.

In some cases once a mistake is identified the Speech Learning Platform 210 stops the student, for example immediately and displays/says using for example the Text-to-Speech (TTS) system “STOP! Try again”.

In some cases, after a number of mistakes for example one or two mistakes, the Speech Learning Platform 210 will say or display the correct answer using TTS, and optionally ask the student to say the correct answer twice.

In some cases, the process continues in a loop till succuss, e.g. the content is pronounced correctly and a high emotion level such as more than 60%, 70%, 80%, 90% LTP.

In the second option where the content is unknown, the audio input is processed and analysed using two model types, simultaneously:
1. A Model based on Phonemes which has a very high error rate—for example worse than 18%; and
2. A Model based on Words that will compensate the high error rate in the Phonemes Model; and
3. A special algorithm should be applied on the above first and second models to provide an accuracy level suitable for Learning.
4. The initial target error rate may be for example 15%, going down to for example 2%. Other rate ranges may be applicable.

The emotion module 216 is configured and enabled, in accordance with embodiments, to receive audio input 217, for example from the client device 220, analyse the audio input 217 and convert the audio input 217 to cognitive and emotional information parameters showing, for example levels of each parameter. e.g. focus, energy, Mental Stress, LTP.

In accordance with embodiments, the emotion module 216 comprises an emotion detection engine 214 and a Biomarkers Processing Module 223.

The emotion detection engine 214 is configured and enabled, in accordance with embodiments, to receive the audio input 217, for example from the client device 220, analyze the audio input 217 to generate one or more Neuro-markers/Biomarkers 221 to the Biomarkers Processing Module 223.

In some cases, the selected Biomarkers levels are displayed in Real-time as part of the feedback to the student.

In some cases, the display includes a dial with numbers from 1 (low) to 5 (high) and colors from Red to Green as shown in FIG. 2A.

The Biomarkers Processing module 223 analyzes the Biomarkers 221 and translates the analyzed biomarkers to Emotion Results/feedbacks 225. The Emotion Results/feedback 225 comprises cognitive results regarding one or more of the focus, energy, Mental Stress and current Long Term Potentiation (LTP) Level of the user's during the specific speech exercise.

In some embodiments, the Emotion Detection Engine 214 is configured and enabled to measure LTD (Long Term Depression), LTM (Long Term Memory).

The feedback as provided by the speech learning system and method, in accordance with embodiments, can be used as a Biofeedback system for learning spoken languages, but also for other areas such: Autism, ADHD, NLP (Neurolinguistic Programming).

In some cases, the system and method may use one or more of the following Biomarkers such as: Energy, Stress, Cognitive Stress, Concentration, Intensive Thinking, Imagination.

These biomarkers may be displayed in Real-time as a Biofeedback of what is occurring in the brain during spoken practice.

Other emotion parameters may be identified and presented in accordance with embodiments.

In some cases, the speech learning platform 210 may display and/or say to the user (e.g. the student) for example in Real-time, on the App or Web application the levels of each of the selected parameters, providing Feedback, such as immediate Feedback, with the intent of the student to improve their function, i.e., try and get to the Green level in the Emotion meter, such as meter 508 shown in FIG. 5B.

In accordance with embodiments, the emotion system 216 is configured to measure and display LTP's strength, for example in Real-Time, to provide a powerful learning tool for the learner.

In accordance with embodiments, the Emotion Detection Engine 214 provides one or more Neuro-markers 221 by analyzing cognitive processes in the user's brain. Advantageously the Emotion Detection Engine 214 provides the feedback without the need of any external device, such as external sensors (e.g. EEG (electroencephalogram) devices)-just sound—and is language agnostic.

In some cases, the Emotion Detection Engine 214 is configured and enabled to measure and display other cognitive properties quickly in real-time. This is done by enabling the user to select 2-3 biomarkers parameters to display through check-boxes. The results will be displayed on meters or dials selected by the user.

According to one embodiment, the emotion detection engine 214 is configured and enabled to automatically provide plurality of Biomarkers, for example 51 Biomarkers (or Neuromarkers), including for example: Stress, Thinking, Confidence, Concentration, Hesitation. These are readily available while measuring, so we can easily choose any Biomarker that we want to display. In some embodiments the present invention may use an algorithm to create a new Biomarker from a combination of several Biomarkers.

In some cases, the Emotion system 216, for example the Emotion detection Engine may include or may use one or more voice analysis technologies such as Nemesysco. An example of Nemesysco is shown in U.S. Pat. No. 6,638,217, which herein is incorporated by reference.

According to one embodiment the Emotion results/feedback 225 and the language practice results/feedback 232 may be transmitted to the client device 220 and may be for example displayed on display 295.

Alternatively or in combination, the Emotion results/feedback 225 and the language practice results/feedback 232 may be transmitted to a Text to Speech (TTS) Engine 234 for generating audio output feedback 219. The audio output feedback 219 may be played at a client device 220, such as through a speaker 290 of the client device 220.

The language learning platform 210 further comprises one or more storage subsystems 251 for storing databases 252. Databases 252 may be of any desired type that stores data. As non-limiting examples, the database 252 can store various exercises downloaded and/or created by teachers, students, textbook, apps and more. In some embodiments the content 209 may be stored or may be part of database 252.

In some embodiments, the content 209 may be received or extracted from the client device 220 and/or from the speech learning platform 210. For example, the content 209 may be stored at the storage subsystem 250 in the client device 220 or at storage subsystem 251 in the Speech learning Platform 210.

In one embodiment, the speech learning platform 210 is stored on and executed by a server 22 as exemplified in FIG. 1. The server 22 which contains processing capabilities, computer readable memory 26, and program instructions executable by the processor 24 to provide the functions of the language learning platform 210 to a client device 220 over a network 28, as depicted in FIG. 1.

In an alternate embodiment, the speech learning platform 210 is stored directly on the client device 220 as a stand-alone application or module that is executed by the local processors(s) 224 on the client device 220, without requiring execution on or access to an external server. The client device 220 may include various computing devices with processing means and computer readable storage, such as desktop computers, laptops, tablets, smartphones and the like.

The speech learning platform 210 is preferably available globally. Users may access the platform using a variety of Internet browsers from personal computers and specified mobile devices, such as tablets and phones.

The speech learning platform 210 may be downloaded from the web or may be included in the user's mobile.

In preferred embodiments, there are no requirements to install any of the platform components on a user's computer. Data may be stored, for example, on the speech learning platform servers or a third party's servers managed on a private web service. All the platform's logic, including that of the adaptive algorithms, may reside on servers within those same environments.

FIG. 3 illustrates a flowchart of method 300 for digital speech learning by a user, using Emotion System 216 and LRRS 215 to generate feedback (e.g. Emotion results/feedback 225 and language practice results/feedback 232) to the user practicing speaking a text of a content 209, for example of a user's second language, in accordance with embodiments. System 100 or system 200 or system 201, for example, may be used to implement method 300. However, method 300 may also be implemented by systems having other configurations.

In some embodiments a user 211 such as a teacher or a student downloads content 209 such as digital learning content, for example from server 22 to the client device 220 (e.g. mobile device). In some cases, the user 211 may receive or select the content 209 to practice from any known source, and download it for example to the back-end of the speech learning platform 210 (e.g. to storage subsystem 251) through a dedicated screen on the app.

The process begins at step 302 when the user starts practicing the content. For instance, the user may choose to record himself while practicing, generating an audio input.

At step 310, an audio input 217 including the user's recorded practiced content is received by at least two Natural Language Processors (NLP Engines), for example simultaneously, in accordance with embodiments. In some cases, the user (e.g. learner) utilizes one or more sensors such as a microphone, (e.g., microphone 280 as found on the user's phone or PC) to speak the content 209 they desire to practice using for example the Speech learning platform 210. The practiced content is recorded, for example automatically to yield the audio input 217 recording.

In accordance with embodiments, the at least two NLP Engines are the Language Recognition and Response System (LRRS) 215 and Emotion System 216 shown in FIG. 2B.

At step 320, the audio input 217 is analyzed using, for example, the LRRS 215. The analysis process 320 includes the following steps: At step 321 the content 209 to be learned by the user is received or extracted. This content 209 may be received from various sources such local or external sources, for example from storage subsystem 251 and/or storage subsystem 250.

At step 322 the LSTT 212 begins the process of acoustic processing comprising converting spoken words to digital text. Specifically step 322 comprises analyzing the audio input, which comprises the spoken language of the content. The audio input is captured through, for example, the microphone or any suitable audio capture device. The received audio input signal may be in analog or digital form and is ready for subsequent processing.

The LSTT 212 transcribes the received audio input recording (e.g. audio input 217) to text output. In accordance with embodiments, the transcribed text output is literally identical (e.g. word by word) to the audio input of the content which the user recorded, e.g., including the user's language mistakes of the practiced content. In accordance with embodiments, the LSTT 212 must not use autocorrection as in traditional STTs.

Specifically, the LSTT 212 analysis process in accordance with embodiments includes the following steps:

a. Acoustic Processing:

Upon receipt of the audio input 217 and content 209, at step 322, the LSTT engine 212 performs acoustic processing to analyze the acoustic features of the speech. This involves the extraction of relevant parameters such as pitch, amplitude, frequency, and other spectral characteristics. The acoustic processing stage aims to transform the raw audio signal into a structured representation suitable for subsequent analysis.

### B. Feature Extraction:

At step 324, the LSST engine 212 further engages, in feature extraction from the processed acoustic signal. This step involves isolating and capturing distinctive features that characterize the speech patterns present in the audio input 217. Extracted features may include phonetic components, prosodic elements, and other linguistic attributes that contribute to a comprehensive understanding of the spoken language.

c. Speech Recognition:

At step 326, the extracted features are utilized in a speech recognition process. The LSTT Engine 212, in accordance with embodiments, MUST NOT use advanced algorithms such as AI at this stage to GUESS what the user should have said. Instead, the LSTT Engine 212 is customized to recognize the mistakes as phonemes and further display/output the mistakes as phonemes.

In some embodiments the LSTT is configured and enabled to identify language mistakes comprising the accuracy and correctness of the language used in the recorded content (e.g. the audio input), including but not limited to grammar, syntax, vocabulary, pronunciation, and semantics.

Hence, the LSTT engine 212 doesn't employ advanced algorithms, including machine learning techniques and neural networks, to compare the extracted features against a vast, pre-existing language model. While traditional STT encompasses a database of phonetic and linguistic patterns, allowing for the recognition and interpretation of the spoken words within the audio input. The system and method in accordance with the present invention avoids automatically fixing the language mistakes included in the audio input. Moreover, the content learned will always be known, and will always be short. Therefore, the LSTT system can do a very short and quick comparison.

d. Text Output:

At step 328, upon successful speech recognition, the LSTT 212 generates a text output 213. This text output 213 represents the exact transcription of the spoken language in the audio output (e.g. the original audio input), including any mistakes made by the user or mispronunciations. The transcribed text output 213 is made available as the final result of the Learning-Speech-to-Text process, providing for example written representation of the spoken words or phonemes.

At step 330 the text output 213 is received at the comparison module 218 and compared with the content 209 (e.g., expected text) to detect speech errors in the user's audio input and to yield language practice result/feedback 232 to the user. The language practice feedback 232 includes one or more of the following examples feedbacks based on the type of the mistake and the number of rounds the user repeated a mistake:

“STOP! Try again” and/or ‘listen to the recording again’.

In accordance with embodiments, the language practice feedback 232 may be displayed audibly and/or textually using for example Text to Speech systems, or other alternative systems.

At step 340, the emotion system 216 analyzes the audio input comprising the spoken language of the content. In one embodiment, the audio input is analyzed simultaneously as the LRRS 215 receives and analyzes the audio input.

It should be noted that the emotion system 216 is Content Agnostic, meaning that it doesn't care what language is tested nor what is said.

Specifically the emotion analysis includes the following steps:

a. Preprocessing (Optional):

Optionally, at step 342 the audio input 217 undergoes preprocessing to enhance its quality and prepare it for analysis. This may involve noise reduction, filtering, and normalization to ensure a consistent input. For example,

b. Feature Extraction:

At step 344, relevant features are extracted from the audio input 217. In the case of speech, features like pitch, intensity, rhythm, and spectral characteristics may be extracted. These features serve as input for the subsequent analysis.

c. Emotion Model Selection:

At step 346, the Emotion Detection Engine 214 employs a pre-trained model or algorithm designed to recognize emotions, in accordance with embodiments. This model could be based on machine learning techniques, deep learning neural networks, or a combination of both. This model is also based on an NLP engine that extracts emotions by analyzing voice frequencies lower than the audible human hearing range.

According to one embodiment the Emotion Detection Engine 214 analyze the audio input to identify and measure emotions and/or LTP level of the user by correlating vocal parameters extracted from the audio input to the emotional state of said user at the time of said recording and/or in relation to said content being recorded. The vocal parameters may be one or more of:
Pitch variation: Assessing the range and frequency of pitch changes in the voice, which can indicate the level of excitement, stress, or emphasis.

Speech rate: Analyzing the speed at which the user speaks, which may reflect nervousness, agitation, or calmness.

Volume: Measuring the loudness or intensity of the voice, which can convey emotions such as anger, enthusiasm, or sadness.

Tone quality: Evaluating the tonal characteristics of the voice, such as smoothness or roughness, which may indicate different emotional states.

Vocal intensity: Assessing the overall strength or forcefulness of the voice, which can reflect emotional arousal or intensity.

### D. Training (Optional):

Optionally, at step 348 a training phase is initiated where it learns patterns and associations between extracted features and labeled emotions using a dataset with known emotional content.

### Emotion Classification:

At step 350 the extracted features are fed into the emotion detection Engine 214, which then classifies the emotional content of the audio input 217 (e.g. audio input recording). Common emotional categories include happiness, sadness, anger, fear, and neutrality. In some embodiments, the emotion classification includes classifying and/or identifying one more specific emotions such as: Thinking, Confidence of what the user said, Hesitation, Concentration, and/or a combination of such.

e. Post-Processing:

Optionally at step 352 the Emotion system 216 may perform post-processing to refine results or address any potential inaccuracies. This could involve considering contextual information, incorporating temporal aspects, or employing additional algorithms to improve accuracy.

f. Emotion Output and Interpretation:

At step 353 the processing steps 342-352 are finalized to yield a final emotion output. The final emotion output may include one or more emotion biomarkers 221 and/or a probability distribution over different emotions.

According to one embodiment steps 342-353 are performed by the Emotion Detection Engine 214 which receives the audio input 217 to generate the biomarkers 221, in accordance with embodiments.

At step 354 the emotion biomarkers 221 are sent, for example, to the Biomarkers Processing Module 223 for processing and/or analyzing the Biomarkers to yield Emotion feedback result 225. In accordance with one embodiment, the Emotion Feedback results comprise cognitive feedback regarding the current Long Term Potentiation (LTP) Level of the user's specific speech exercise. In some embodiments, the emotion feedback result 225 comprises a measured strength value for LTP, determined for example in real-time. The strength value may be scaled to fall within a predefined range, such as between 1 and 10 or between 1 and 100 as illustrated in FIG. 2A.

At step 356, the system calculates the acquired emotion feedback and the language practice feedback results by comparing them both and/or separately to a predefined threshold value. In case both the graded emotion feedback and the language practice feedback results meet or exceed the specified threshold, e.g. indicating the user successfully reached both language and required LTP level, the speech learning process ends, and optionally the user may procced and practice a different new content, for example a higher level practice. Optionally, for example subsequently, a feedback message, such as “Excellent, you have succeeded,” may be presented via display or auditory means. Conversely, if one or both the graded emotion feedback and the language practice feedback results below the threshold, e.g., indicating the user didn't reach the language mastery level and/or the LTP level, the system redirects the flow to step 302 where the content practice is repeated.

In some cases, the above steps are continued in a loop till success is achieved. Success may defined for example as providing a correct answer quickly while reaching the top LTP score. In some cases, the success may be based on adjustable threshold, for instance 70% in the beginning of the learning process, up to 90% to advance to the next step, however other definition of succuss may be defined according to the language platform provider.

In other words, in case the system requires repeating the practice it means that the material studied has not yet been internalized in the learner's mind, so the learned language is not yet firmly established. It should be noted that even though the grammatical aspect of the language is correct and the learner gives a correct answer, e.g. the language practice feedback results meet or are above the specified threshold, as long as the material is not well absorbed in the learner's mind, it teaches us that further study of the material is required.

For example, if the emotion result (e.g. LTP is less than 90% and/or the language practice result is correct (e.g. above the threshold) than the language practice of the content is repeated. This step involves iterative practice sessions wherein the user repetitively engages with and records the same content. Subsequently, steps 320 through 354 are iterated within a loop until the performance metrics surpass the threshold, ensuring an enhanced learning outcome.

In some cases, following a number of student mistakes, for example, after two mistakes, the language platform will say and/or display the correct answer using for example a STT Speech-to-Text engine, and ask the student to say the correct answer twice.

Whenever the term “student” is used in the context of the present invention, it may refer to any user or learner or any specific individual or group of individuals which use the methods and systems of the present invention.

The present patent application hereby incorporates by reference the content of the article titled “Contributions of memory circuits to language: the declarative/procedural model” authored by Michael T. Ullman, originating from the Brain and Language Laboratory at Georgetown University, Washington, DC, USA, and dated Oct. 29, 2003.

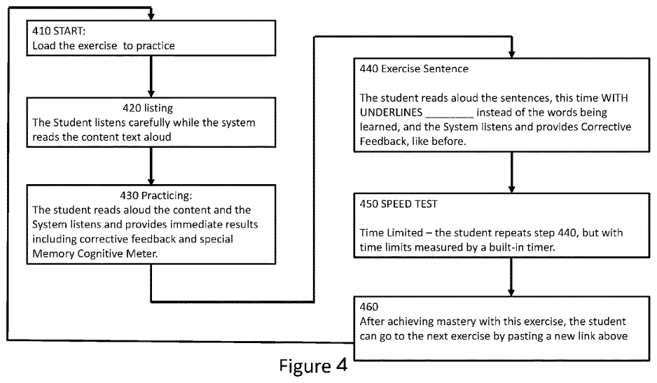

FIG. 4 illustrates a flowchart 400 detailing the steps for a student to engage with the digital speech learning platform, in accordance with embodiments. Specifically, the flowchart 400 illustrates the steps taken by the student to achieve language mastery. System 100 or system 200, for example, may be used to implement method 400. However, method 400 may also be implemented by systems having other configurations.

The speech learning process starts at step 410 where the content including the exercise to be practiced is received or loaded, for example at the student's device. For example, the student may receive or download a link to the content. The content includes for example, a list of sentences to be practiced by the student.

Optionally, at step 420 the student's listens carefully while the device reads the content text aloud.

At step 430 the student reads aloud the content, for example the complete sentences, while the system listens and provides immediate results including corrective feedback such as right or wrong feedback and a Memory Cognitive Meter (e.g. emotion result). This meter, in accordance with embodiments shows the student if he really learned comprehended and caught the language achieving MasteryMeter LTP.

Optionally, at step 440, the student may engage in practice sessions wherein the content is presented with underlines instead of the target words. During this practice, the system actively listens and delivers corrective feedback, as in step 430.

In some cases, if the student answer is incorrect, then the learning platform, asks the student try again and provide a correct answer. After the second consecutive mistake, the platform display the mistake as heard as illustrated in FIG. 5B in element 506. As explained the system doesn't use AI modules to try and to guess what the student meant as there is a need to show the student the incorrect answer and let him try again to provide his correct answer. For example: If the student says:” this is an encypedia”, the learning platform will not to guess and display “encyclopedia”.

Optionally, at step 450 the student repeats step 440 and/or step 430, but with time limits measured for example by the system's timer. For example, as illustrated in FIG. 5C showing a screenshot of the speech Learning Platform 210 including a timer 512 which may be reset and automatically initiated each practicing irritation. The content 209 includes a number of sentences such as sentence 504 which includes blank underlined sections which the user needs to complete in a time limit as part of the learning process. Specifically, sentence 504 is “I like ______ blue T-shirt over there better ______ the red one” which the user needs to complete, say and record himself while saying these sentence 504. As shown in FIG. 5C, if the student provides a correct answer and his LTP level is for example more than 4 (e.g. colored green) then a feedback ‘correct answer’ is displayed and the Emotion Meter 508 displays the student's LTP level.

At step 460, once the student achieves mastery with this exercise, he can proceed to the next exercise at step 410 by downloading and practicing new content. For example, FIG. 5D illustrates a screenshot of exercise result summary of the speech Learning Platform 210 which present a number of sentences included in the content (e.g. ten sentences in English) and practiced by the student. At the right section of each sentence, a feedback ‘X’ or ‘V’ relating to the language correctness is presented, for example, green color “v” for a correct answer and red ‘X’ for an incorrect answer followed by an emotion meter such as an LTE emotion meter related to each corresponding practiced sentence in the same raw.

In further embodiments, the processing unit may be a digital processing device including one or more hardware central processing units (CPU) that carry out the device's functions. In still further embodiments, the digital processing device further comprises an operating system configured to perform executable instructions. In some embodiments, the digital processing device is optionally connected to a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

Those of skill in the art will recognize that many smartphones are suitable for use in the system described herein. Those of skill in the art will also recognize that select televisions with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof. In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In some embodiments, the system disclosed herein includes software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

The language recognition and response system comprises a language detection module configured to determine the spoken language utilized by a user. The system further comprises a speech recognition module adapted to transcribe the user's spoken utterances into textual form. An error detection and correction module analyzes the transcribed text to identify any deviations from established linguistic norms and conventions.

Upon detecting such a deviation, the error correction module initiates an iterative feedback loop. Within this loop, the system presents a graphical representation of the intended word or phrase (e.g. “encyclopedia”) to the user, thereby indicating the error in the user's pronunciation or articulation. The system then prompts the user to repeat the utterance. This cyclical process continues until the user's spoken output matches the canonical form, at which point the error correction module terminates the feedback loop.

The iterative feedback loop and graphical error indication functionalities enable the system to provide corrective guidance to the user, allowing them to improve their pronunciation and facilitate accurate speech recognition for the target language.

1-23. (canceled)

24. A computer-implemented method for digital speech learning by a user, comprising:
receiving a recording, via a network to a client device, said client device comprising a processor and a display, wherein the recording comprises an audio input of the user speaking a content;
analyzing said audio input, using the processor, wherein said analyzing comprises:
processing the recording using a Language Recognition and Response System (LRRS), said processing comprises:
transcribing the audio input to text, wherein said transcribed text comprises correct language text and one or more language mistakes;
identifying the correct language text and the one or more language mistakes in said audio input to yield language practice results; and
processing the audio input using an Emotion System, wherein said processing comprises:
analyzing the audio input to identify and measure Long-Term Potentiation (LTP) level of the user by correlating vocal parameters extracted from the audio input to the emotional state of said user, at the time of speaking the content, in relation to said content;
displaying on said display said transcribed text;
measuring if said LTP level and the number of language mistakes are above or equal a predefined threshold and if said LTP level and the number of mistakes are below said threshold then:
providing a feedback to the user to repeat recording the content; and
repeating and analyzing the recorded content until the LTP level and number of mistakes are above the predefined threshold.

25. The method of claim 24, wherein said transcribing comprises:
converting the one or more language mistakes in the audio input into text output using a Language Speech to Text Engine (LSTT), said LSTT is configured and enabled to not automatically correct the language mistakes; and
comparing the text output to the content, using a comparison module, to yield the language practice results or said feedback.

26. The method of claim 25, wherein the language practice results comprise the one or more language mistakes and feedback, said feedback comprises a correct or incorrect reply in respect to the audio input.

27. The method of claim 24, comprising:
providing feedback on the accuracy or correctness of the language used in the recorded content.

28. The method of claim 24, wherein processing the audio input using the Emotion System comprising:
processing the audio input, using an emotion detection engine to yield a plurality of biomarkers;
processing said plurality of biomarkers, using a biomarkers processing module to yield emotion results or said LTP or said feedback; and
displaying said emotion results or feedback.

29. The method of claim 24, comprising:
highlighting language mistakes in said transcribed text.

30. The method of claim 24, wherein said language mistakes are one or more of:
grammatical errors; incorrect verb tense usage, subject-verb agreement issues, and improper sentence structure within the given content.

31. The method of claim 24, comprising:
setting a time limit for exercising said content;
measuring whether the user made any language mistakes within said time limit; and
determining if the user's performance LTP level exceeded the predetermined threshold within said time limit.

32. The method of claim 27, further comprising using a Text-to-Speech (TTS) engine to audibly present said emotion results or feedback.

33. The method of claim 24, wherein said processing the audio input using an Emotion System comprising:
analyzing the recording to identify one or more emotions by correlating vocal parameters extracted from the recording to the emotional state of said user at the time of recording and in relation to the content being recorded.

34. The method of claim 32, comprising:
measuring the intensity or level of said identified emotion, resulting in one or more emotion parameters; and
displaying the identified emotions along with their corresponding intensity levels.

35. The method of claim 24, comprising:
playing the content audibly.

36. The method of claim 24, comprising:
replaying the content audibly if said LTP level and the number of mistakes are below said threshold.

37. The method of claim 24, wherein the content is unknown, the audio input is processed and analysed using two model types, simultaneously:
a) a Model based on Phonemes which has an error rate worse than 18%; and
b) a Model based on Words that will compensate the error rate in the Phonemes Model.

38. A system for digital speech learning by a user, comprising:
a storage subsystem configured and enabled to store content;
a client device comprising a microphone configured and enabled to record the user speaking said content and to yield a recording comprising audio input of said content; and
a processor, said processor comprises:
a Language Recognition and Response System (LRRS), configured and enabled to:
transcribe the audio input to text, wherein said transcribed text comprises correct language text and one or more language mistakes;
identify the correct language text and the one or more language mistakes in said audio input; and
an emotion system configured and enabled to:
analyze the audio input to identify and measure Long-Term Potentiation (LTP) level of the user by correlating vocal parameters extracted from the audio input to the emotional state of said user at the time of said recording and in relation to said content being recorded; and
wherein said processor is configured to:
measure if said LTP level and the number of language mistakes are below a threshold and if the affirmative then:
provide feedback to the user to repeat recording the content; and
repeat and analyze the recorded content until the LTP level and number of mistakes are above the predefined threshold.

39. The system of claim 38, wherein the measured level of the LTP is displayed as an emotion meter, wherein said emotion meter provides a visual representation of the intensity or magnitude of the LTP detected in the recording.

40. The system of claim 38, wherein the emotion system is configured and enabled to:
analyze the audio input to identify and measure emotion level of the user by correlating vocal parameters extracted from the audio input to the emotional state of said user at the time of said recording and in relation to said content being recorded.

41. The system of claim 38, wherein the measured level of each identified emotion is displayed as an emotion meter, wherein said emotion meter provides a visual representation of the intensity or magnitude of each emotion parameter detected in the vocal recording.

42. The system of claim 38, wherein said vocal parameters are selected from the group consisting of: Pitch variation, Speech rate, Volume, Tone quality, and Vocal intensity.

43. The system of claim 38, comprising:
a TTS (text to speech) system for playing the content audibly.
